(19) United States
(12) Patent Application Publication
(10) Pub. No.: US 2003/0036031 A1
(43) Pub. Date: Feb. 20, 2003

(54) Light-emitting handpiece for curing photopolymerizable resins

(76) Inventors: Joseph Alexander Lieb, Narberth, PA (US); Nathaniel H. Lieb, Narberth, PA (US)

Correspondence Address: WARREN W. KURZ, 2275 Springtown Hill Road, Hellertown, PA, 18055, US

(21) Appl. No.: 10/146,170

(22) Filed: May 15, 2002

Related U.S. Application Data
(60) Provisional application No. 60/313,681, filed on Aug. 20, 2001.

(51) Int. Cl. A61C 3/00

(52) U.S. Cl. 433/29

(57) ABSTRACT

A light-emitting handpiece for curing light-curable dental resins and similar materials. In general appearance, the handpiece is designed to resemble a conventional dental drill. Preferably, the handpiece comprises a housing defining a tubular handle portion that is adapted to contain a power pack for energizing an LED light source, a head portion for supporting an LED in a position to project radiation outwardly therefrom; and (iii) a neck portion that serves to interconnect the head and handle portions. Preferably, at least the head and neck portions of the housing are integrally formed from a common, thermally conductive material, preferably aluminum. In use, the head and neck portions of the handpiece housing operate to provide a heat sink for the LED. Circuitry within the handpiece housing operates to prevent overheating of the housing and the LED source. Preferably, the head portion of the handpiece housing supports a conical reflector or the like that operates to redirect off-axis LED emissions towards a desired focus zone of high flux density.

### CROSS REFERENCE TO RELATED APPLICATION

Reference is made to the commonly owned U.S. Provisional Application No. 60/313681, filed on Aug. 20, 2001 in the names of Alexander Lieb and Nathaniel Lieb, entitled “LED Handpiece,” from which this application claims priority for the commonly disclosed subject matter.

### FIELD OF THE INVENTION

The present invention relates to improvements in apparatus for curing (i.e., hardening) photoinitator-containing resins of the We used, for example, by dentists in performing aesthetic and restorative procedures on teeth. More particularly, it relates to improvements in light-emitting handpieces of the type that employ one or more light-emitting diodes (LED'S) as a photo-curing light source for dental composites and the like.

### BACKGROUND OF THE INVENTION

U.S. Pat. No. 6,102,695 issued to Ostewalder et al. discloses a portable, light-emitting handpiece for curing photopolymerizable resins of the type used in dental repair and restoration procedures. In appearance, the device resembles a conventional battery-operated toothbrush. It comprises an elongated, cylindrically-shaped handle portion that is adapted to be contain a small battery pack, a somewhat bulbous head portion that, in this case, contains an array of light-emitting diodes (LED's), and a slender neck portion that interconnects the handle and head portions. The light source is said to be “self-contained in that, in use, there is no physical connection between the device and a remote electrical power source, such power source being housed, as noted, in the handle portion. Preferably, the LED array is positioned on a concave edge or surface of a printed circuit board, whereby each of the individual LED's directs its radiation generally towards a common focal point at which a soft, resinous material capable of being photo-polymerized is located. The LED's are selected to emit at wavelength that is readily absorbed by photo-initators (e.g., camphor quinone) within the resinous composite, whereupon hardening of the resin begins. Typically, the LED's are selected to emit in the blue spectral region. To attain a flux density required to cure conventional dental resins within an acceptable time period, the device uses a relatively large number of relatively low power LED's. In the disclosure, at least nine, and upwards of 25, LED's are preferred, each operating independently and each being separately encapsulated. As may be appreciated, the use of a relatively large number of independent LED's gives rise to a relatively bulky head component that may be difficult to properly position relative to a small resinous surface within the mouth of a dental patient. Further, the larger the array, the more difficult it is to collimate the multitude of light emissions to produce a desired area, ideally about 6 to 12 mm in diameter in the case of dental applications, and of substantially uniform flux density. Furthermore, large LED arrays can result in a spillage of light into areas adjacent the resin to be cured, giving rise to annoying reflections toward the user. While the number of LED's may be reduced by driving the LED's at current levels higher than those for which the particular LED's are rated, this approach would tend to overheat the LED's, leading to premature failure.

In U.S. Pat. No. 5,420,768, issued to Kennedy, another relatively compact and self-contained LED photocuring device is disclosed. Here. a light-emitting matrix comprising a large number of LED's disposed on a ceramic substrate is used as the light source. A metallic heat sink comprising a block of aluminum arranged in a position juxtaposed to the ceramic substrate is said to dissipate any heat generated by the LED's in operation. An arcuate light guide mounted in front of the LED matrix serves to transmit the LED-emitted light to a desired location. While this device is conceptually capable of curing conventional photo-curable polymers, undesirably long exposure times would be required for doing so, owing in part to the relatively small (low mass) heat sink used to dissipate heat from the LED's, and optical losses in the relatively bulky light guide.

In U.S. Pat. No. 6,200,134, issued to Kovac et al., a light-emitting dental handpiece, somewhat similar to those described above, is disclosed in which the problem of overheating of a relatively small array of LED's is addressed by the provision of a small electric fan mounted in the neck portion of the device. When energized, the fan directs cooling air towards the rear-surface of an LED array. Obviously, the use of such active, power-consuming cooling devices is undesirable from several standpoints, including cost, noise, vibrations, cooling efficiency and complexity of manufacture.

In U.S. Pat. No. 6,331,111, to issued to Cao, a hand-holdable resin-curing light system is disclosed in which the problem of light source overheating is also addressed. Here, two different systems are disclosed, one being a portable, self-contained system, including a battery pack for the resin-curing light source, and the other being a non-portable chair-side system comprising a hand-holdable light source housing that is connected to a remote power source via a suitable power cable. The light-emitting elements of the light systems preferably comprise one or more LED's or diode lasers, each individual element being located atop a heat sink that is intended to dissipate sufficient thermal energy from the element to enable the light system to operate continuously at a power level and for a time sufficient to effect resin-curing. In a preferred embodiment, each light-emitting element of an array of such elements is positioned within its own cup or well-shaped heat sink, and the latter, in turn, is mounted atop a substantially larger heat sink that acts to dissipate thermal energy collectively produced by all of the individual well-shaped heat sinks atop it. Preferably, the inner wall of each of the heat-sinking wells in which the light-emitting elements are positioned is angularly disposed with respect to the normal to the light-emitting elements, whereby light emitted from the respective lateral sides of the elements is re-directed and essentially collimated with respect to the light emitted from the top surface of the elements. In all of the different embodiments disclosed in this patent, the heat sink(s) is physically located in the head of the device and is spaced from that portion of the housing normally handled or contacted by the clinician in performing the resin-curing procedures. This geometry and spacing, coupled with the relatively large size of the arrays of light-emitting elements suggested, gives rise to a relatively bulky head and neck portions that are not readily manipulated inside the mouth of a dental patient. Also in those embodiments in which tandem heat sinks are used to dissipate thermal energy, there is an undesirable inefficiency at each interface between adjacent heat sinks.

### SUMMARY OF THE INVENTION

In view of the foregoing discussion, an object of the present invention is to overcome the above-noted disadvantages of the prior art's resin-curing light sources by providing a light-emitting handpiece that is both compact in size yet highly efficient in dissipating thermal energy from a semiconductive light source, preferably, an LED light source.

Another object of this invention is to provide a resin-curing light-emitting handpiece that, owing to its compact size and shape, can readily access any surface in the mouth without resort to external light guides and the like.

A further object of the invention is to provide a resin-curing light-emitting handpiece in which a substantial portion of the light source housing itself functions to dissipate sufficient thermal energy from the vicinity of a heat-generating LED, allowing the LED to be operated for a time interval sufficient to effect resin curing.

The above and other objects of the invention are achieved by the provision of an improved, preferably self-contained, light-emitting handpiece that in general appearance, preferably resembles a conventional dental drill or the like. According to a preferred embodiment, such handpiece comprises (a) an LED light source that is selectively energizeable by the application of electrical energy to emit electromagnetic radiation of a wavelength at which photo-activated resins are responsive to initiate curing; and (b) a housing defining (i) a handle portion that is adapted to be held by the user and, most preferably, contains a power pack for electrically energizing the LED light source; (ii) a distal head portion that supports the LED light source in a position to project radiation outwardly therefrom towards a desired focal area and (iii) a neck portion that serves to interconnect the head and handle portions. According to the invention, at least the head portion of the handpiece housing, and, more preferably, at least a major portion of the neck portion as well, are formed from a thermally conductive material, most preferably solid aluminum. These housing portion(s) operate as a heat sink that is sufficiently massive to dissipate thermal energy emanating from the LED light source at a rate that enables the source to operate at a power level sufficient to cure an optically-activated resin located at the focal area within a time period of less than about 10 seconds, and more preferably less than 5 seconds. Preferably, at least the head and neck portions are integrally formed to facilitate heat transfer. Optionally, the handle portion is also thermally conductive and is thermally couple the other housing portions to further dissipate heat from the LED source. Also preferred is that the LED light source comprises a single high power (greater than 500 milliwatts/cm² output power) LED package, typically comprising from one to four adjacent light-emitting dies within a single encapsulating structure, mounted directly atop a planar, heat-conducting surface of the head portion of the handpiece housing. Preferably, the head portion of the handpiece housing also supports an optical element that functions to reflect non-axial rays from the light source towards the desired focal area to provide a desired area size of substantially uniform flux density. Preferably, such optical element comprises either a clad optical rod, or a suitably shaped reflector that surrounds the light source and reflects radiant energy towards the desired focal area. Alternatively, a conventional imaging conduit comprising a plurality of optical fibers is used to convey light energy from the LED source to the vicinity of the resious composite to be cured.

By virtue of the design of the thermally conductive handpiece housing, a single high power LED package can be used to effect curing of conventional light-activated resins. This results in a significantly smaller and more readily manipulated light-emitting handpiece than is characteristic of comparable prior art devices that use a relatively large matrix of discrete LED packages to achieve rapid curing of light-activated resins.

The invention and its advantages will be better understood from the ensuing detailed description of preferred embodiments, reference being made to the accompanying drawings in which like reference characters denote like parts.

### BRIEF DESCRIPTION OF THE DRAWINGS

FIG. 1 is a cross-sectional illustration of the light-emitting dental handpiece structured in accordance with a preferred embodiment of the invention;

FIG. 2 is a top view of a preferred head portion of the dental handpiece of FIG. 1;

FIG. 3 is a cross-sectional illustration of the preferred head portion of the dental handpiece of FIG. 1;

FIG. 4 is a cross-sectional view of the head portion of the dental handpiece of FIG. 1 showing an alternative light reflector; and

FIG. 5 is a perspective view of an alternative light-emitting dental handpiece that is energized by an external power source.

### DETAILED DESCRIPTION OF THE INVENTION

The use of plastic resins containing light initiators to effect curing for dental restoration and repair is well known. Typical light-curable dental resins of the type with which the invention is useful comprises a 1:1 mixture, by weight, of bis-phenol-2bis(2-hydroxypropyl) methacrylate and tri(ethylene glycol) dimethylacrylate monomers containing a camphoroquinone photoinitiator and a tertiary amine reducing agent. Such a photoinitiator is sensitive to light in the blue spectral region to initiate curing of the resin. Depending on the depth and size of a restoration, multiple layers and attendant curing steps are usually required. Since some restorations can involve as many as twelve curing steps and, with conventional light sources, take as long as five minutes or more of light exposure, a portable, fast curing, readily manipulated light source will have great appeal to clinics to relieve tedium, gain procedure continuity, save time and increase productivity. As will be appreciated from the ensuing description, the light-emitting handpiece of the invention provides these advantages.

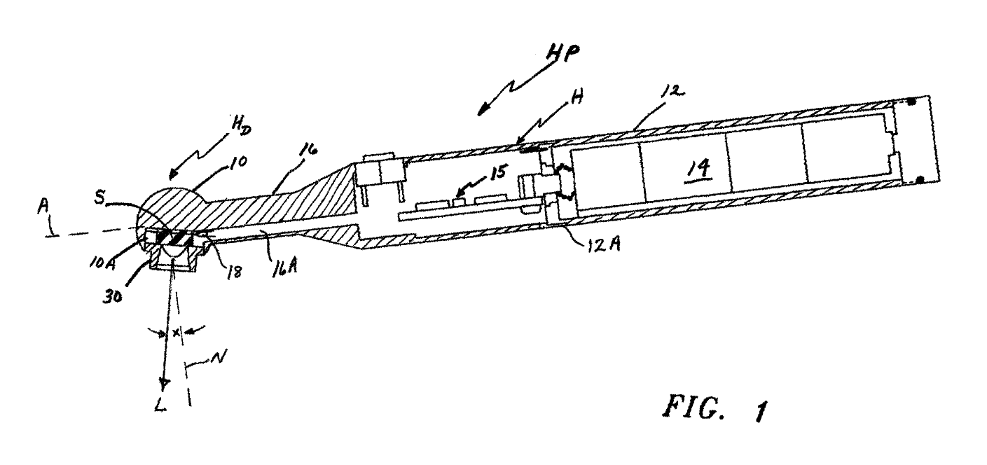

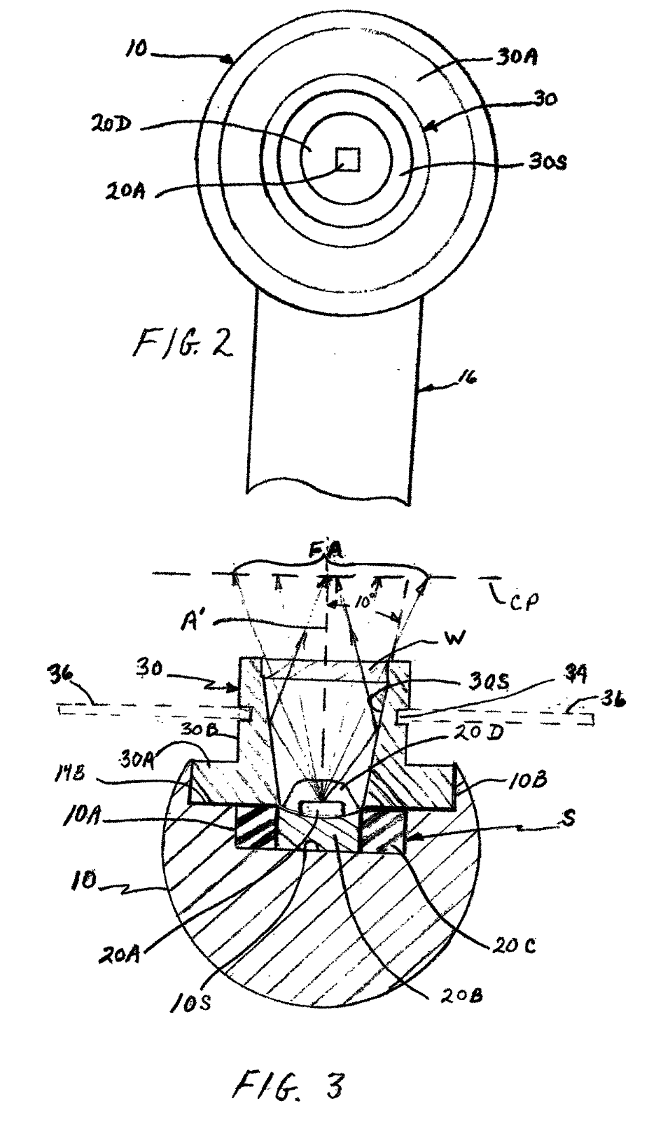

Referring now to FIG. 1, a self-contained, light-emitting handpiece HP structured in accordance with the present invention is illustrated in cross-section. As depicted, the handpiece is similar in size and appearance to many dental drills, thereby providing a familiar and readily acceptable shape to the dental clinician who is most apt to use the device. A preferred overall length for the handpiece is about 7 inches (about 175 mm.) The handpiece comprises an elongated housing H that supports, at its distal end H_{D}, a selectively energizeable light source S, preferably a single high-power LED structure (described below). The distal end of housing H defines a substantially solid head portion 10 having a drilled hole 10A of about 10 to 14 mm in diameter and about 4 mm in depth. As explained below, light source S is positioned atop the planar bottom surface 10S of hole 10A (shown in FIG. 3) to project light L at an angle x (preferably between about 10 and 45 degrees) measured with respect to the normal N to the longitudinal axis A of the housing. As shown, the head portion is preferably rounded In shape, e.g., spherical, to avoid any sharp edges or surfaces that might tend to irritate mouth of a dental patient when the handpiece is used by a dental clinical to cure dental resins. This shape is also highly advantageous in that it provides excellent heat dissipation to the surrounding atmosphere by convection and radiation. At its proximal end Hₚ (closest to the user), housing H defines a hollow, cylindrically shaped handle portion 12 that is adapted to be held by the user and to receive a re-chargeable battery pack 14 and control circuit 15 for selectively energizing the light source. As shown, the handle portion comprises two pieces press fit together at a junction 12A, thereby enabling ready access to the control circuitry. A slender neck portion 16 having a flared base 16B serves to interconnect the head and handle portions of the handpiece. For aesthetics, as well as to provide good visibility of the head portion to the clinician, the neck portion is relatively slender; but, as explained below, it may be substantially thicker than shown, especially in the region in which it interfaces with the head portion to enhance its heat-dissipation capacity.

As explained below, an essential characteristic of the handpiece housing H and, in particular the head and neck portions thereof, is its ability to dissipate heat. As noted above, the preferred light source S comprises a high-power LED that, by its very nature, generates substantial thermal energy while energized to emit radiant energy. Unless this thermal energy is quickly and continuously dissipated, the LED will fail within a matter of seconds. In accordance with an important aspect of the present invention, the handpiece housing H itself, rather than a heat sink associated with the LED package that is mounted within such housing, is thermally coupled to the LED and used as the principle heat sink for dissipating the thermal energy generated by the LED. Owing to its mass, its thermally-conductive material and its shape, the handpiece housing, and in particular the head portion, dissipates heat at a rate that enables the LED light source to operate for a time and at a power level sufficient to effect curing of a light-activated resin within a matter of seconds, preferably less than 10 seconds, and more preferably between 2 and 5 seconds. Further, due to its heat-dissipating properties and rounded shape, the head portion of the handpiece housing will prevent the LED junction from rising to a level at which catastrophic failure occurs (typically about 105 degrees Centigrade), and will prevent its surface temperature from rising to a level that is uncomfortable to touch, typically about 50 degrees Centigrade.

To provide the above-noted heat-dissipating characteristic, it is highly preferred that at least head portion of the handpiece housing is made of a solid heat-conducting material, most preferably aluminum. While other heat-conductive materials may be used (e.g. copper, brass, or even suitably doped heat-conductive plastics), aluminum is preferred due to its relatively light weight, its low cost and its machineability. The mass (i.e., weight) of the aluminum head portion, of course, will determine its capacity to dissipate heat, and the mass required to effect the requisite continuous operation of any LED will depend on the LED's thermal output. For the preferred LED source (described below) and for the desired time interval for sustained operation (about 5 seconds), it has been found that the mass of an aluminum heat sink should be between about 5 grams and 20 grams and most preferably about 17 grams. When such a mass of aluminum is thermally coupled to the LED source, the source can operate for a time interval far exceeding that required to cure conventional composites. While this heat-dissipating mass can be concentrated in the housing's head portion alone, in which case the diameter of the head will be relatively large, it is preferred that a portion of the mass be contained in the integral neck portion 16 so that the head size can be proportioned as shown. Preferably, the head and neck portions of the housing are integrally formed from one piece of aluminum so that thermal energy can flow unattenuated by any artificial barrier or interface between these housing portions. The preferred mass of an aluminum head portion 10 is preferably about 9 grams, and the preferred mass of the tapered aluminum neck portion 16 is about 8 grams. A spherically rounded head with the LED centrally located therein minimizes any potential for localized heating of the head that would cause such the head to be uncomfortably hot to touch.

As shown in FIG. 1, the neck portion 16 of housing H is substantially solid, except for a single small bore hole 16A formed in the neck's solid distal end (closest to the head portion). Bore hole 16A is sized to receive two pair of wires. One pair of wires serves to provide electrical connection between the light source S and the light-control circuit 15 located in the hollowed-out handle portion of the handpiece housing, and the other pair serves to connect the control circuit to a heat-sensing element 18 (e.g. a thermistor or the like) positioned adjacent the light-emitting element that senses an overheating condition of the light source. The control circuit 15 is further discussed below.

As noted above, light source S preferably comprises a single, relatively high-power light-emitting diode (LED) structure. Such structure preferably comprises one or more (up to four) dies encapsulated by a single light-transmissive dome. A particularly preferred LED structure is that manufactured by LumiLeds Lighting, a Joint Venture between Agilent Technologies and Phillips Lighting, and sold under the trademark Luxeon Power Light Source. This particular LED structure operates to convert approximately 5 watts of input power to a radiant output power (flux density) of about 800-1000 mW/cm². Further, this LED structure typically emits at approximately 470 nanometers, well within the absorption band of a conventional dental resin's camphor quinone photoinitiator. At such a flux density and emission wavelength, a typical layer of dental resin of the type described above can be cured by an exposure of less than ten seconds. But operating continuously for even such a relatively short time interval would, absent some form of heat management, result in a certain failure of the LED. Thus, as provided by the manufacturer, the Luxeon LED is thermally coupled, via a suitable epoxy or the like, to a relatively massive metal heat sink that serves to dissipate sufficient thermal energy to enable the device to operate continuously indefinitely. Unfortunately, such a large heat sink is so massive as not to be readily adapted for use in the handpiece housing described herein. In fact, when used in the handpiece of the invention, the heat sink provided with the Luxeon LED is carefully removed and discarded.

Referring to FIG. 3 the LED light source S described above (absent the manufacturer's heat sink and circuit board) is positioned atop the planar surface 10S at the base of the drilled hole 10A formed in the solid spherical head portion 10 of the handpiece housing. As illustrated, source S comprises a light-emitting die 20A supported by a substrate 20B and encased by a plastic casing 20C. A transparent plastic dome 20D encapsulates the light-emitting die 20A. The respective planar bottom surfaces of the LED substrate and casing are pressed against planar surface 10S by the rim 30A formed at the base of a light-focusing reflector member 30 that serves to focus the LED output towards focal area FA located at a desired resin-curing plane CP. Rim portion 30A is press fit into an enlarged rim 10B surrounding hole 10A. By virtue of the smooth contact between planar surface 10S and the bottom surface of the LED substrate 20B, an excellent thermal coupling is made between these surfaces, thereby enabling a good transfer of thermal energy from the LED to the heat sink provided by the head and neck portions of the handpiece housing H. Optionally, a thermally-conductive epoxy or the like can be used to bond the LED to planar surface 10S. The thermal energy transferred to the handpiece housing is dissipated radially throughout the relatively large mass of the head and then throughout the integral neck portion 16. To further dissipate the thermal energy generated by the LED light source during its operation, it is highly preferred that the entire handpiece housing H is made of a heat-conductive material, preferably aluminum, so that even the handle portion serves to dissipate heat from the LED source; however, as noted, it has been found that only the head portion 10 and, preferably, some portion of the neck portion 16 be made of a heat-conductive material, and the remainder of the neck and handle portions could, if desired, be manufactured of some other less thermally conductive material.

To provide a substantially uniform and high flux density over a focal area of approximately 7-12 mm in diameter at a distance of approximately 8-10 mm from the light source, two different approaches are preferred. According to a first preferred embodiment, shown best in FIG. 3, the reflector member 30 has a reflective, conically-shaped inner wall 30S is positioned relative to the light-emitting die 20A so that the reflective inner well re-directs off-axis rays emanating from the top surface of the die towards the desired focal area FA. A preferred half-cone angle for the reflector is about 10 degrees measured from the axis A′. The shape of the reflector depends, to some extent on the angular light distribution produced by the light source. If appropriate, the reflective surface may be parabolic, rather than conical, in shape. As noted above, the reflector member is supported by a circular flange 30A extending outwardly from the base of its cylindrically-shaped outer wall 30S. Flange 32 is press fit into a circular recess 10B surrounding the drilled hole 10A formed in the head portion of the handpiece housing to provide support for the reflector. The conical reflector has a length, measured along axis A′ from the bottom surface of flange 30A, of between about 5 mm. and about 10 mm., with a length of about 8 mm. being most preferred. Preferably, a thin transparent window W is positioned at the outer end of the reflector member and serves as a shield against dust and the like. A groove 34 formed in the outer wall of the reflector about midway between its respective ends serves to support an optional light shield 36. The later is preferably orange in color and serves to transmit virtually all visible light except blue light. Thus, the light shield allows the user to view the focal area through the light shield while, at the same time, being shielded from light emitted by the LED and reflected by surfaces within the focal area. The cylindrical external appearance of the reflector member 30 and its size (preferably extending about 5 mm. above flange 30A and having an outside diameter of about 6 or 7 mm.) provides the user with a good indication of the direction of the LED output when the device is energized.

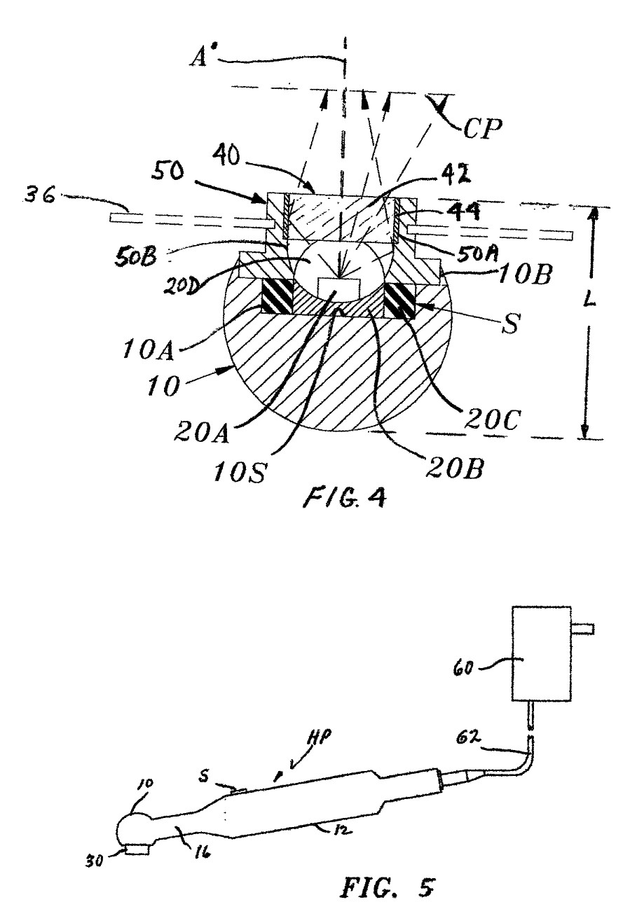

Referring to FIG. 4, an alternative reflector for transporting the LED's radiant output to the desired focal area in the curing plane CP comprises a single, clad optical rod 40. The latter comprises a central cylindrical core 42 of light-transmissive material, surrounded by a thin cladding layer 44 of optical material having a substantially lower index of refraction than the core material. Rod 40 is supported in the bore 5OA of a flanged tubular member 50 having an outer appearance like that of reflector member 30 (FIG. 3) with the proximal end of the rod adjacent the encapsulating dome 20D of the LED source. Rod 40 has a length of between about 3 mm. and 6 mm., and a diameter of between about 5 mm. and 10 mm. Owing to the difference in refractive index of core 42 and cladding layer 44, radiant energy emitted by the LED is transmitted from the proximal end of the rod to its distal end by one or more internal reflections. Light emitted by the LED source will enter the proximal end of the rod either directly from the LED die(s), or indirectly upon reflecting from a suitabit contoured surface at the base of bore 50A. Rod 40 is advantageous in that its presence atop the LED provides protection for the LED source, act as a protective window.

Whether the LED output is conveyed by reflector 30 (shown in FIGS. 1 and 3) or by the clad rod of FIG. 4, it is preferred that the overall length L of the head portion 10, as measured from the back surface of the head to the forward-most edge of the light-transmitter, should be less than about 20 mm., whereby the head portion 10 can readily access and irradiate dental surfaces located in the rear portion of a child's mouth.

As an alternative to the above-noted reflectors used to redirect light energy from the LED towards the curing plane, a conventional imaging conduit composed of a plurality of fused optical fibers could be used. Such a device would be substituted for the cladded rod 42 shown in FIG. 4 and could be used to transmit light along a non-rectilinear path (e.g., an arcuate path) between the source and the desired curing plane.

A preferred power source 14 for the LED light source and control circuit 15 comprises a nickel metal hydride battery capable of providing an output voltage between about 3.6 and 4.2 volts with an output capacity of about 400 milliamp hours. Alternatively, a rechargeable lithium ion battery, e.g., with an output of 3.7-4.2 volts and an output capacity of from 1600 to 2200 milliamp hours, can be used. The preferred control circuit 15 includes a D.C. to D.C. converter that steps up the battery's output voltage to about 7.0 volts. Circuit 15 also includes a timing circuit that operates to provide an audible “beep” every, say, 2 to 5 seconds, to alert the handpiece user how long the light source has been energized. Further, circuit 15 includes a heat-sensitive cut-off circuit that responds to a signal provided by the heat sensing element 18 to disconnect the power applied to the LED source in the event the ambient temperature in the vicinity of the source exceeds a preset value. Circuit 15 also includes a timing circuit that operates to shuts power to the LED after a predetermined period of time, say, after about 15 seconds of continued operation, whereby accidental discharging of the power source is avoided. Switch S is a momentary contact switch that energizes and de-energizes circuit 15 when depressed.

Referring to FIG. 5, an alternative embodiment of the invention is shown in which the light-emitting handpiece of the invention is not self-contained, i.e., its LED light source and control circuits are powered by a remote power source via a conventional high-to-low voltage transformer 60 and power cable 62. Nevertheless, thermal energy generated by the LED light source is dissipated in the thermally conductive housing, as described above.

While the invention has been described with particular reference to preferred embodiments, it will be clear to those skilled in the art that various modifications can be made without departing from the spirit of the invention, and such modifications are intended to fall within the scope of the appended claims.

What is claimed is:

1. A light-emitting handpiece for curing photopolymerizable resins, said handpiece comprising:
(a) an LED light source; and
(b) an elongated housing defining (i) a handle portion that is adapted to contain a circuit for selectively energizing said LED light source; (ii) a distal head portion supporting said LED light source in a position to project radiation outwardly therefrom towards a desired focal area, said LED light source being operatively connectable with said circuit; and (iii) a neck portion that serves to interconnect the head and handle portions, at least said head portion of said housing being formed from a thermally conductive material and being thermally coupled to said LED light source to dissipate thermal energy emanating from said LED light source when said LED light source is energized.

2. The handpiece as defined by claim 1 wherein said distal head portion is substantially spherical in shape, and wherein said LED light source is mounted at the base of a hole formed in said head portion

3. The handpiece as defined by claim 1 wherein said distal head portion is substantially solid and is made of aluminum.

4. The handpiece as defined by claim 1 wherein said distal head portion has a mass exceeding 10 grams.

5. The handpiece as defined by claim 2 wherein said LED light source is positioned atop a planar surface at the base of said hole and is physically urged thereagainst to effect thermal coupling between said LED light source and said head portion of said housing.

6. The handpiece as defined by claim 1 wherein said head and neck portions are integrally formed from a common thermally conductive material, whereby said neck portion also serves to dissipate heat from said LED fight source.

7. The handpiece as defined by claim 6 herein said thermally conductive material is selected from the group consisting of aluminum, copper and brass.

8. The handpiece as defined by claim 6 wherein said thermally conductive material is aluminum, and wherein the combined mass of said head and neck portions is at least 10 grams.

9. The handpiece as defined by claim 1 wherein said handle portion is adapted to contain a power supply for said LED light source.

10. The handpiece as defined by claim 9 wherein said handle portion comprises a thermally conductive material that is thermally coupled to said neck portion of said housing and thereby further dissipates thermal energy from said LED light source.

11. The handpiece as defined by claim 1 wherein said LED light source is adapted to provide at least 500 milliwatts of output power per square centimeter at said focus area.

12. The handpiece as defined by claim 1 wherein housing contains a control circuit for preventing overheating of said LED light source, said control circuit including a heat-sensitive element positioned adjacent said LED light source for controlling electrical power applied to said LED light source in response to the ambient temperature sensed by said heat-sensitive element.

13. The handpiece as defined by claim 1 wherein said head portion of the handpiece housing supports an optical element adapted to redirect off-axis LED emissions towards said focus area.

14. The handpiece as defined by claim 13 wherein said LED light source is mounted at the base of a hole formed in said distal head portion, and wherein said optical element is contained in a cylindrically-shaped housing extending outwardly from said base,

15. The handpiece as defined by claim 13 wherein said optical element comprises a reflective surface that surrounds said LED light source.

16. The handpiece as defined by claim 13 wherein said optical element comprises a clad optical rod that serves to transmit LED emissions towards said focus area by one or more internal reflections.

17. The handpiece as defined by claim 13 wherein said optical element comprises an imaging conduit comprising a plurality of fused optical fibers that serves to transmit LED emissions towards said focus area by multiple internal reflections

18. The handpiece as defined by claim 1 wherein said head portion supports said light source to project light at an angle between 10 and 45 degrees measured with respect to the normal to the longitudinal axis of said housing.

19. In a light-emitting dental handpiece for curing photopolymerizable dental resins, said handpiece comprising:
(a) an LED light source; and
(b) a housing defining (i) a tubular handle portion that is adapted to contain a circuit for selectively energizing said LED light source; (ii) a rounded head portion supporting said LED light source in a position to project radiation outwardly therefrom towards a focus area of relatively high flux density, said LED light source being operatively connectable with said circuit; and (iii) a neck portion that serves to interconnect the head and handle portions, the improvement comprising:
said head and neck portions of said housing being integrally formed from a common, thermally conductive material and being thermally coupled to said LED light source to dissipate thermal energy emanating from said LED light source when said LED light source is energized.

20. The dental handpiece as defined by claim 19 wherein said rounded head portion is substantially solid and is made of aluminum.

21. The handpiece as defined by claim 20 wherein said distal head portion is substantially spherical in shape, and wherein said LED light source is mounted within a hole formed in said head portion.

22. The handpiece as defined by claim 21 wherein said distal head portion has a mass exceeding 10 grams.
